(19) United States
(12) Patent Application Publication
(10) Pub. No.: US 2012/0210323 A1
(43) Pub. Date: Aug. 16, 2012

(54) DATA PROCESSING CONTROL METHOD AND COMPUTER SYSTEM

(75) Inventors: Masaaki Hosouchi, Zama (JP); Kazuhiko Watanabe, Yokohama (JP); Hideki Ishiai, Kawasaki (JP); Tetsufumi Tsukamoto, Nagareyama (JP)

(73) Assignee: HITACHI, LTD., Tokyo (JP)

(21) Appl. No.: 13/388,546

(22) PCT Filed: Mar. 12, 2010
(86) PCT No.: PCT/JP2010/001771

§ 371 Date: Apr. 27, 2012

(30) Foreign Application Priority Data
Sep. 3, 2009 (JP) 2009-203272

(51) Int. Cl. G06F 9/46

(52) U.S. Cl. 718/102

(57) ABSTRACT

A rerunning load is reduced for reducing the risk of exceeding a specified termination time after abnormally ending a job net. Even if the same data processed by jobs within a job net is replaced with split data of sub-jobs and some of sub-jobs have been abnormally ended, the job net is continued. For each split data, a state and/or an execution server ID of each job are stored, and the progress of a job net is managed. Only split data whose state is not “normal” is to be processed by rerunning. Based on states of execution servers, on whether or not intermediate files transferred between jobs is shared among execution servers, and on whether or not an output file is deleted after ending the subsequent job, it is judged whether or not intermediate files can be referred to and from what job the rerun is to be performed.

### TECHNICAL FIELD

The present invention relates to techniques for scheduling jobs of processing data.

### BACKGROUND ART

A method for controlling a job net (also referred to as a job network) that associates a plurality of batch jobs with each other is disclosed in, for example PATENT LITERATURE 1.

In order to enable a service using an execution result of a job net to start at a predetermined start time, the job net needs to be terminated within a predetermined time. However, the processing time of a batch job depends on the amount of data to be input/output, and therefore if the amount of data increases, the job net cannot be terminated within a predetermined time. As the countermeasure of this, a job scheduling method is disclosed in, for example PATENT LITERATURE 2, in which the batch job of processing a large amount of data is speeded up, by splitting data to allocate the split data to respective jobs and performing parallel processing on a plurality of computers. In the job scheduling method of Patent Literature 2, data is split in advance, job definitions are generated, the number of the definitions being the same as the split number, and a relationship between pieces into which data is split (hereinafter referred to as “pieces of data” or “split data” and the job definition is recorded on a parallel-processing management table. In scheduling, a job to be executed is judged with reference to the parallel-processing management table, and the job definition including the identification data of the job is given to the job management.

### CITATION LIST

### Patent Literature

PATENT LITERATURE 1 JP-A-2006-277696

PATENT LITERATURE 2 JP-A-2002-14829

### SUMMARY OF INVENTION

### Technical Problem

Among job nets, there is such a job net that the number of jobs of processing a large amount of data is not one, data is transferred between jobs while sorting or processing a large amount of data, and the same data is processed in a plurality of jobs. In Patent Literature 2, there is no description on the job net.

In the conventional job scheduling methods of job nets including the method of Patent Literature 1, because there is neither relationship nor definition between the respective jobs of processing the split or assigned or allocated data in the job net definitions, the execution result or execution location of a job that has already processed data is not considered when the data is allocated to a subsequent job. For this reason, even if only some of jobs have been abnormally ended due to a data format error or the like, a job net should be interrupted, resulting in an increase in the processing amount during rerunning, increasing the risk of not being able to terminated the job net within a predetermined time.

The objective of the present invention to provide a data split processing control system for a job net that can reduce the risk of exceeding a specified estimated termination time even if some of split data processed in at least one job within a job net has been abnormally ended.

### Solution to Problem

In order to improve the above-described problem, the present invention comprises:
a means for defining an execution sequence of a series of jobs which belong to the same job net and process the same data;
a means for assigning data IDs for uniquely identifying pieces of data into which data is split;
a means for sending a request to execute a sub-job together with a data ID of one of the pieces of data to a computer, the data of a first job that is one of a series of jobs being replaced with the pieces of data;
a means for receiving a termination state and a data ID of a sub-job;
a means for memorizing split data management information having a set of a data ID, a termination state, and a job identifier for uniquely identifying a first job corresponding to the sub-job within a job net; and
a means for sending a request to execute a sub-job together with the data ID of one of the pieces of data to a computer, the data of a second job being replaced, with reference to the split data management information, with pieces of data indicated by data IDs of the split data management information whose job identifier is an identifier of the second job to be executed immediately after the first job in accordance with the execution sequence and whose termination states are not normal, among pieces of data indicated by data IDs of the split data management information whose job identifier is an identifier of the first job and whose termination states are normal.

### Advantages Effects of Invention

According to the present invention, a risk of exceeding a specified estimated termination time can be reduced even if some of split data to be processed in at least one job within a job net has been abnormally ended.

### BRIEF DESCRIPTION OF DRAWINGS

FIG. 1 shows a hardware configuration form of the present invention.

FIG. 2 shows an example of the overview of execution of a job net.

FIG. 3 is a schematic diagram of rerunning after abnormally ending a sub-job in this embodiment.

FIG. 4 shows the structure of job net information.

FIG. 5 shows the structure of job information.

FIG. 6 shows the structure of split data management information.

FIG. 7 shows the structure of abnormally ended sub-job management information.

FIG. 8 shows the structure of execution server management information.

FIG. 9 is a flowchart of a job net scheduling process in a job scheduling processing section.

FIG. 10 is a flowchart of a sub-job scheduling process in the job scheduling processing section.

FIG. 11 is a flowchart of an execution server selection process in the sub-job scheduling process.

FIG. 12 is a process flowchart of sending/receiving to/from an execution server in the sub-job scheduling process.

FIG. 13 is a flowchart of an input data preparation process in the sub-job scheduling process.

FIG. 14 is a flowchart of a job canceling process in the job scheduling processing section.

FIG. 15 is a process flowchart of a sub-job execution control processing section.

### DESCRIPTION OF EMBODIMENTS

### Embodiment 1

An embodiment of the present invention is described with reference to respective figures.

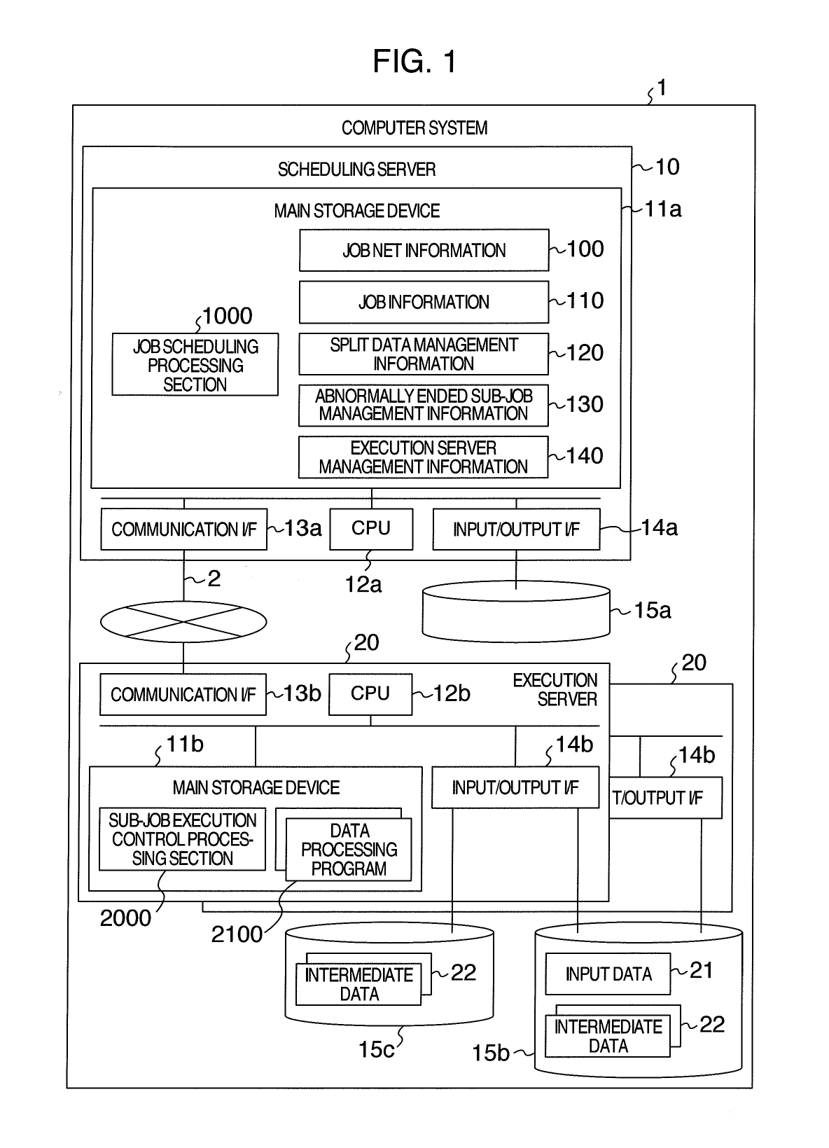

FIG. 1 shows the hardware configuration of a computer system 1 to which the present invention is applied. The computer system 1 comprises: a scheduling server 10, i.e., a computer on which program codes of a job scheduling processing section 1000 of the present invention runs; at least one execution server 20, i.e., a computer on which program codes of a sub-job execution control processing section 2000 runs, the sub-job execution control processing section 2000 executing a sub-job 32 upon receiving a request from the server 10. Here, a sub-job 32 is an execution unit of a job 31 generated by splitting the job 31. The data to be processed in the job 31 is split and the split data is allocated to each sub-job 32, and therefore an executed data processing program is the same for sub-jobs generated from the same job but the data to be processed differs. Moreover, a set of a series of jobs 32 which are executed in accordance with the defined execution sequence by one time scheduling request is referred to as a job net 30. In the job net 30, a job executed immediately before a certain job in accordance with the execution sequence is defined as a prior job. Moreover, a job executed immediately after a certain job in accordance with the execution sequence is defined as a subsequent job.

The server 10 includes: a main storage device 11a that stores the instruction codes of a program of the job scheduling processing section 1000; a CPU (Central Processing Unit) 12a that loads, interprets, and executes the instruction codes of the program of the processing section 1000; a communication interface 13a that sends/receives an execution request and an execution result to/from one or more servers 20 via a communication channel 2; and an input/output interface 14a.

The main storage device 11a is allocated to management tables to be read or updated by the job scheduling processing section 1000 which include job net information 100, job information 110, split data management information 120, abnormally ended sub-job management information 130, and execution server management information 140.

The execution server 20 includes: a main storage device 11b that stores the instruction codes of a program of the sub-job execution control processing section 2000; a CPU 12b that loads, interprets, and executes the instruction codes of the program of the processing section 2000; a communication interface 13b that sends/receives an execution request and an execution result to/from the server 10 via the communication channel 2; and an input/output interface 14b. A storage device 15b is accessible from a plurality of execution servers 20 via the interface 14b. A storage device 15c is a virtual file (RAM disk) within the storage device or the main storage device 11a which is accessible via the interface 14b only from a specific execution server 20.

The main storage device 11b includes instruction codes of a data processing program 2100 of respective sub-jobs 32 activated from the processing section 2000. An input data file 21 input to the program 2100 of the first job 31 of the job net 30 is stored in the storage device 15b. An intermediate data file 22 stored in the storage device 15b or in the storage device 15c, is the output data of the program 2100 of each job 31 belonging to the same job net 30 and also the input data to the next job 31 within the job net 30. The file 21 may be a single file, or may be split into files for respective sub-jobs in advance. A file 22 is generated for each sub-job. The above-described each server or each processing section may be rephrased as each processing unit. The above-described each server or each processing section can be also realized by hardware (e.g., circuitry), a computer program, or a combination of these (e.g., a part thereof is executed by a computer program and another part is executed by a hardware circuitry). Each computer program can be read from a storage resource (e.g., memory) provided in a computer machine. Each computer program can be installed into the storage resource via a recording medium such as a CD-ROM or a DVD (Digital Versatile Disk), or can be downloaded via a communication network such as the Internet or a LAN.

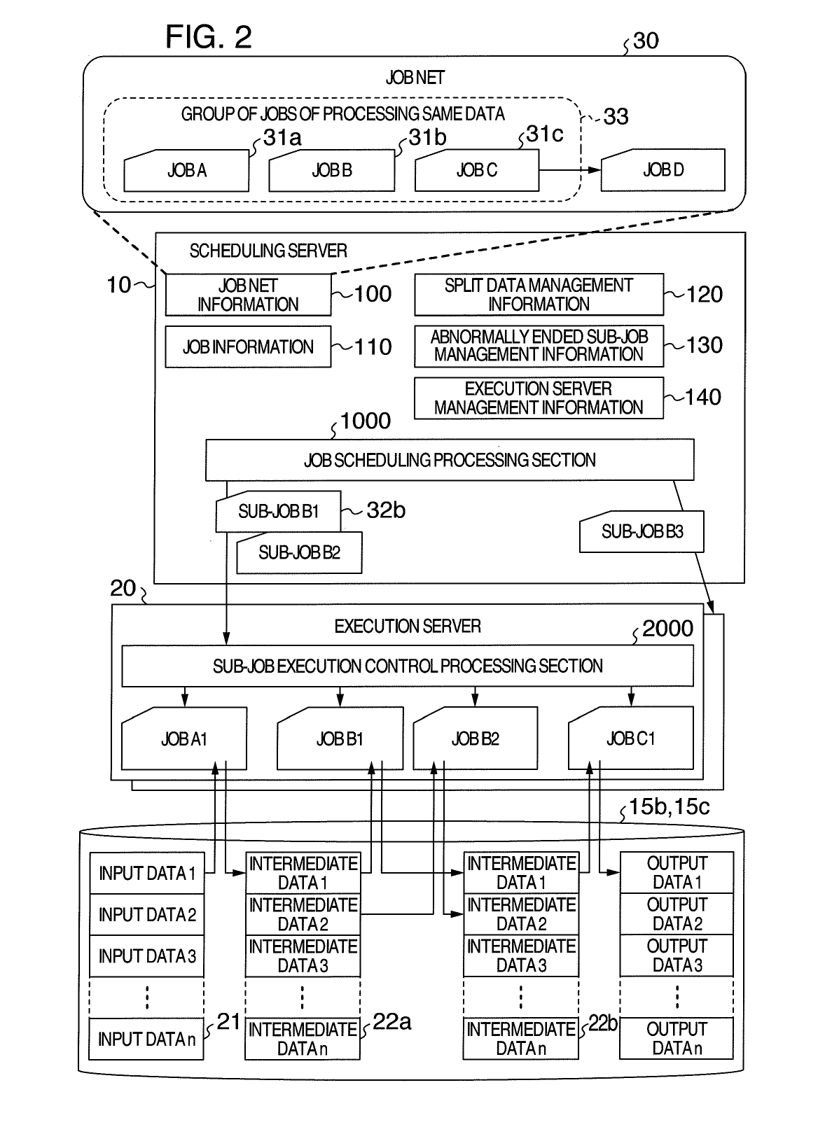

FIG. 2 shows an example of the overview of execution in the job net 30. In the job net 30, four jobs (a job A, a job B, a job C, a job D) are assumed to be defined in the information 100. It is assumed that among four jobs, the intermediate data file 22 output from the job A is input to the job B, and the intermediate data file 22 output from the job B is input to the job C. That is, the same data in the input data file 21 of the job A is assumed to be sequentially processed in three jobs: the job A, job B, and job C.

When the job net 30 is executed, the job scheduling processing section 1000 reads the information 100 and the information 110 into the main storage device 11a from a file within the storage device 15a connected via the interface 14, and generates the information 120 and the information 140 in the main storage device 11a. The job scheduling processing section 1000 generates sub-jobs 32 from the job 31, and requests the processing section 2000 in the executable execution server (the execution server having some room in the unused multiplicity) 20 to execute the sub-jobs 32.

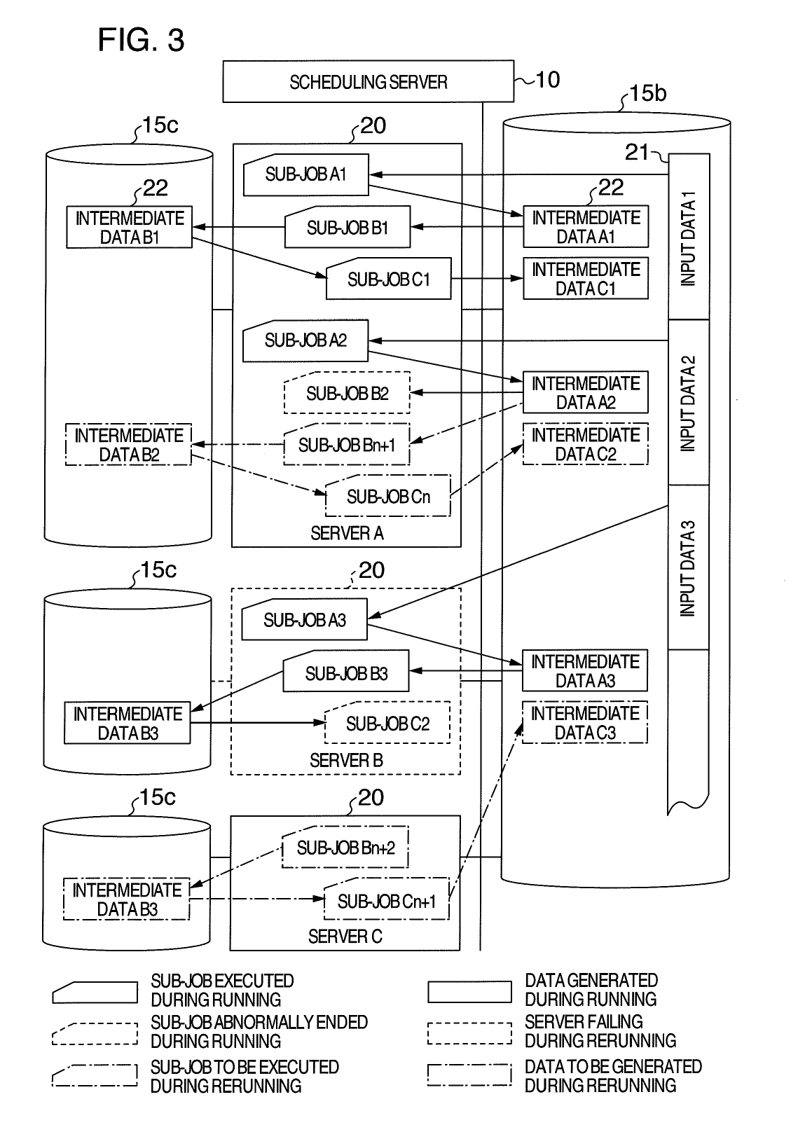

FIG. 3 shows a state and a rerunning range where the job net 30 of the example shown in FIG. 2 has been abnormally ended. In FIG. 3, it is assumed that a sub-job B2 and a sub-job C2 have been abnormally ended. Moreover, it is assumes that the execution server B is in a failure state when the job net is rerun. Because the processing load of the job A is heavy, the intermediate data file of the job A will be left without being deleted so as not to rerun the job

A even if the job B to which it is input has been terminated. Because the processing load of the job B is light, the performance during normal execution is prioritized over the rerunning time and the output of the job B is stored in the high speed unshared storage device 15c, and will be deleted after normal termination.

Even if the sub-job B2 has been abnormally ended, the data other than data 2 allocated to the sub-job B2 is allocated to respective sub-jobs (sub-job Bn+1 and sub-job Cn) of the job C and is executed, without interrupting the execution of the job net. When the job net is rerun, the data 2 is allocated to the sub-jobs of the job B and the sub-job of the job C for execution. For data 3 allocated to a job C2, it is judged that the intermediate data file is currently stored in the unshared storage device 15c due to the server B's failure, and executes from the job B in which an intermediate data file to be input is present (sub-job Bn+2 and sub-job Cn+1).

This embodiment is characterized in that in order to obtain the execution range during rerunning of a job net, the progress state in the job net or the sharing/deletion state of the output file is recorded or referred to for each split data and in that when a job is canceled, the data output by executed sub-jobs is deleted.

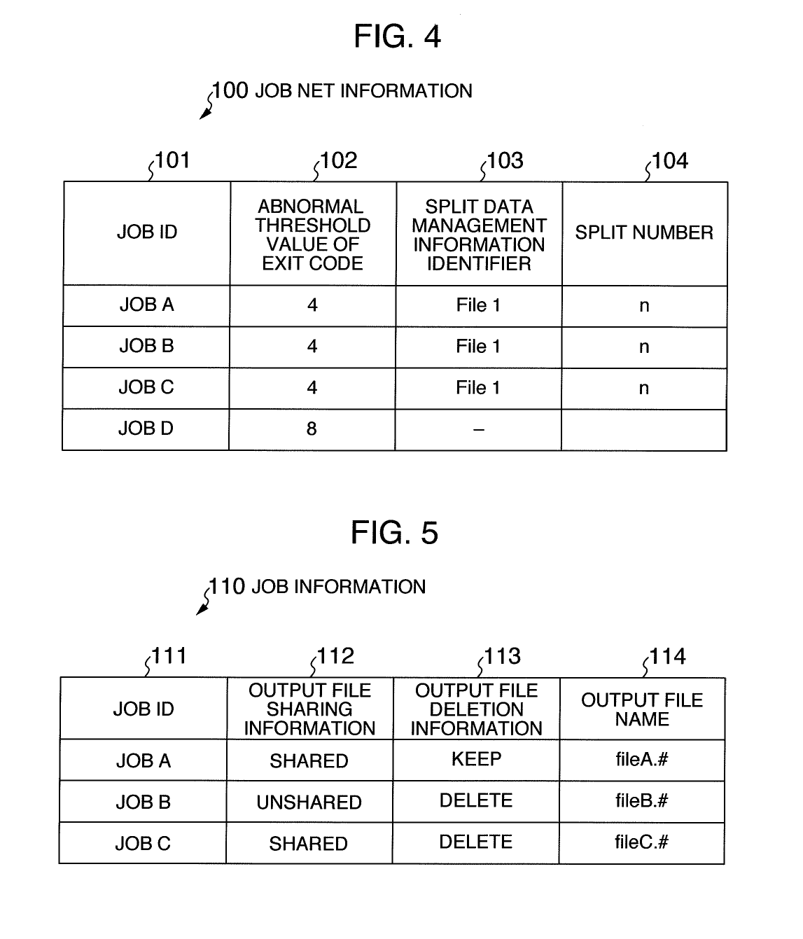

FIG. 4 shows the structure of the job net information 100 that is the definition information about a job net 30. Each entry which is present in the job net information 100 and corresponds one-to-one with a job 31 includes a job ID 101 that is an identifier for uniquely identifying the job 31 within the job net 30, an abnormal threshold value 102 of a exit code, an identifier 103 for uniquely identifying the split data management information 120 in the whole server 10, and a split number 104 of input data.

The job ID 101 is, for example, a sequence number which the job scheduling processing section 1000 generates. The threshold value 102 is a lower-limit integer value of the exit code of the data processing program 2100 executed in a sub-job 32, the exit code being deemed as abnormally ending. The identifier 103 is, for example, the pathname of a backup file of the information 120.

FIG. 5 shows the structure of the job information 110 that is the definition information about a job 31. Each entry which is present in the job information 110 and corresponds one-to-one correspondence with a job 31 includes a job ID 111, output file sharing information 112, output file deletion information 113, and an output file name 114 that is the name of an intermediate data file to be output. The information 112 and the information 113 are referred to in order to determine whether or not an intermediate data file is accessible when a sub-job is rerun. A symbol “#” in the output file name 114 indicates that “#” is to be replaced with a split data ID. The reason why the split data ID is added to the output file name is that an intermediate data file is generated for each split data ID and thus each intermediate data file needs to be identified.

In the output file sharing information 112, “shared” is stored when an intermediate data file or an output file from a sub-job is output to the storage device 15b shared among the execution servers 20, and “unshared” is stored when the intermediate data file is output to the storage device 15c that is not shared among execution servers 20. Where an intermediate data file is stored in the shared storage device 15b, even if an execution server 20 fails, the intermediate data file is accessible from other execution servers. If an intermediate data file is output to a virtual file within the high-speed unshared storage device 15c or within the main storage device 11b, the intermediate data file cannot be accessed where the execution server 20 has failed. However, when the processing amount of a job is relatively small and a time required for rerunning is less, a priority may be given to the performance during running and the intermediate data file may be output to an unshared storage device.

In the output file deletion information 113, when the subsequent sub-job to which the intermediate data file is input is terminated, if the intermediate data file is deleted, “DELETE” is stored, and if not deleted, “KEEP” is stored.

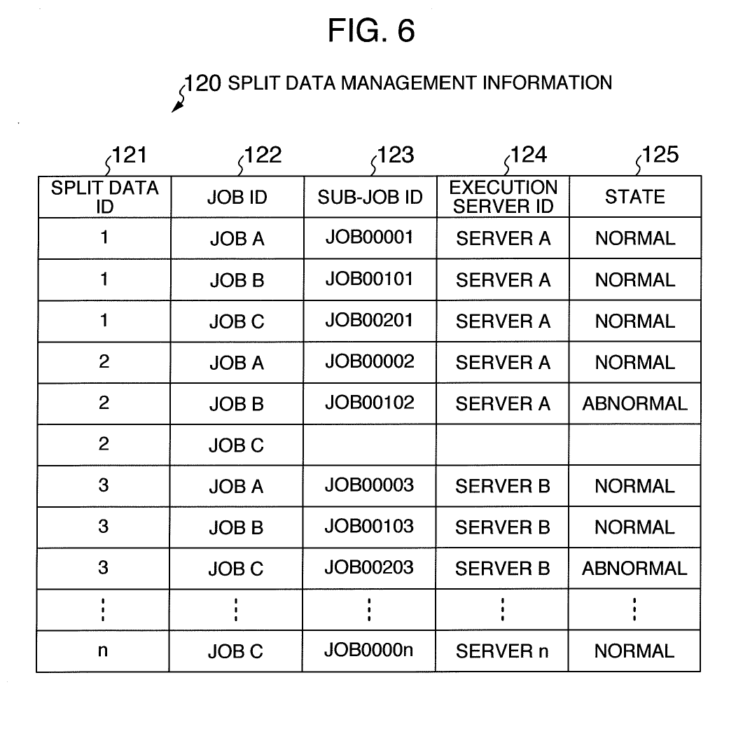

FIG. 6 shows the structure of the split data management information 120. Each entry which is present in the information 120 and corresponds one-to-one with the split data includes: a split data ID 121 that is an identifier for uniquely identifying piece of data into which an input data file 21 within the job net 30 is split; a job ID 122 that is the job identifier of a sub-job having processed the split data; a sub-job ID 123 for uniquely identifying a sub-job within a job or within a job net; an identifier 124 of the execution server 20 having executed the sub-job; and a sub-job state 125. In the sub-job state 125, when the exit code of a sub-job having processed split data falls below the threshold value 102, “normal” is set; when it exceeds the threshold value 102, “abnormal” is set; when a sub-job is running, “running” is set, and when the sub-job has not been executed yet even once, “blank” is set, respectively.

Note that, where the sub-job is always executed from the beginning of a job net during rerunning, the execution server information other than a sub-job executed lastly within the job net is unnecessary, and therefore in FIG. 6, entries other than the entry of the sub-job executed lastly are unnecessary. Moreover, without setting the sub-job state 125, the job ID 122 may be assigned only when the state of a sub-job is “normal”.

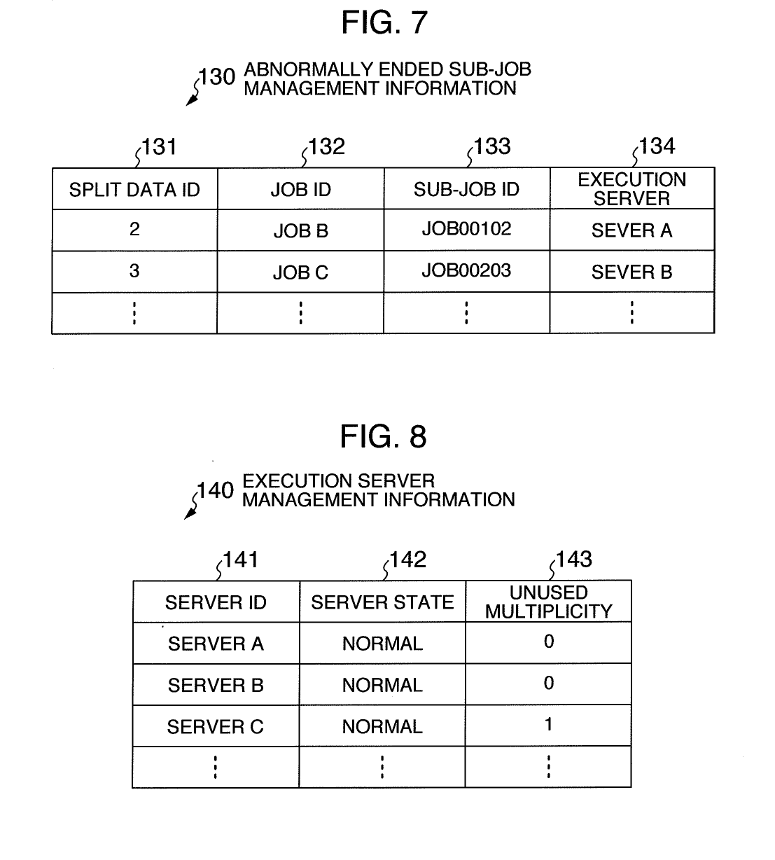

FIG. 7 shows the structure of the abnormally ended sub-job management information 130. An entry of the split data management information 120 with the same data ID and the same job ID is overwritten by rerunning the sub-job. However, in cases where a failure cause has not been pinpointed yet but an estimated termination time is running out and a priority is given to rerunning over the pinpointing of the cause (in cases where an execution server 20 is the cause and thus the job will be normally terminated if the job is executed by another execution server 20), the information required for pinpointing the cause needs to be left.

For this reason, FIG. 8 shows the structure of the execution server management information 140. The execution server management information 140 includes entries, the number of entries being the same as the number of the execution servers 20. Each entry includes: a server ID 141 for uniquely identifying an execution server 20; a server state 142 that indicates a “normal” state where a sub-job is currently running or can be submitted to the execution server 20, or an “abnormal” state such as a server failure; and an unused multiplicity 143, i.e., the number of sub-jobs that can be submitted to the execution server 20.

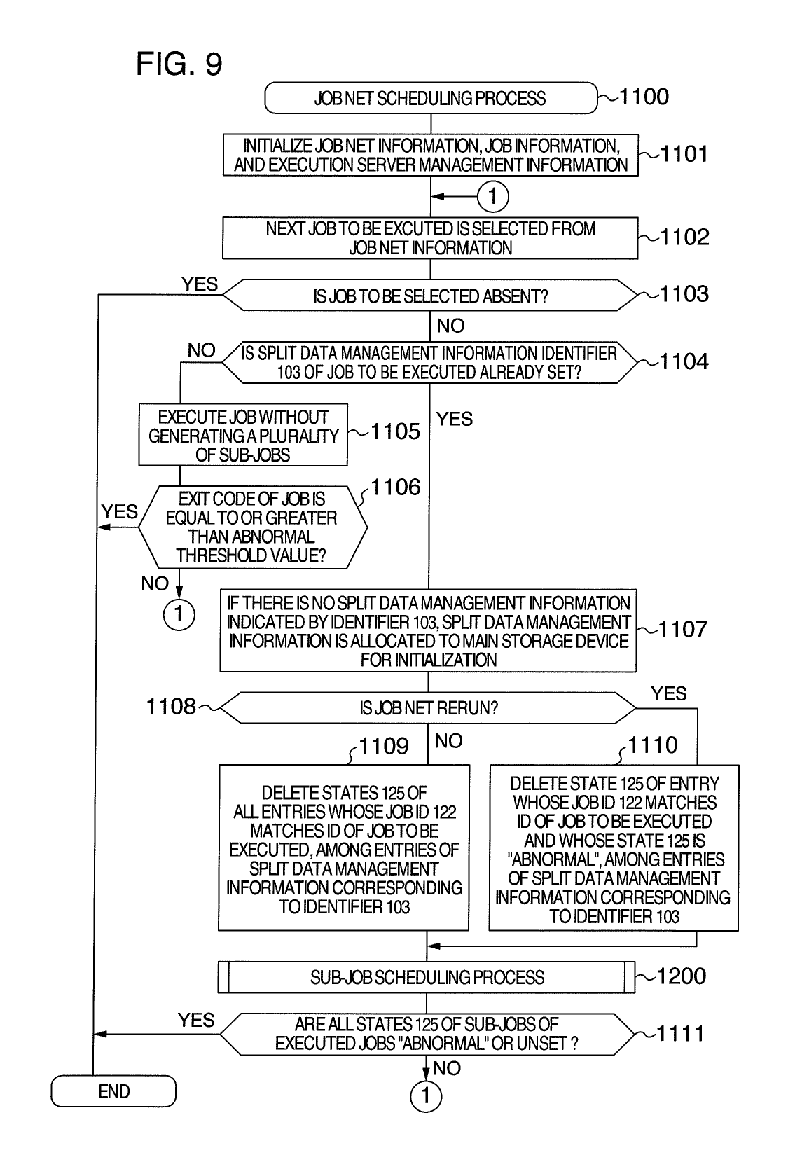

FIG. 9 shows a flowchart of a job scheduling process in the job scheduling processing section 1000. First, the job net information 100, the job information 110, and the execution server management information 140 are allocated to the main storage device 11a for initialization (step 1101). For initialization, the job net information 100 and the job information 110 are loaded, for example, from files in the storage device 15a recording predefined job net information and job information. For initialization, the execution server management information 140, for example, a list of a predefined server ID and the unused multiplicity is loaded, and a health check result of the execution server 20 indicated by the server ID is assigned to the server state,.

Next, a job (job in the entry next to the prior job) to be executed next is selected from the job net information 100 (Step 1102). If all the jobs have already been executed and a selected job is absent, the process 1100 is terminated (Step 1103). If the split data management information identifier 103 of the entry of a selected job is blank (Step 1104), then an arbitrary execution server 20 is requested to execute the job without splitting the job (Step 1105). If a received execution result is equal to or greater than the abnormal threshold value 102, the job net scheduling process is terminated, but if the received execution result is less than the abnormal threshold value 102, the next job is selected (Step 1106).

Where the identifier 103 is not blank, if the split data management information 120 indicated by the identifier 103 is neither present in the storage device 15a nor in the main storage device 11a, the split data management information 120 is allocated to the main storage device 11a for initialization (Step 1107). For each job of each entry whose identifier 103 of the job net information 100 is not blank, the same number of entries as the split number 104 are generated, and, numbers from 1 to a number indicated by the split number 104 are sequentially assigned to the split data ID of the generated entry. The job ID 101 is assigned to the job ID 122, and the state 125 and the identifier of the execution server ID 124 are set blank. When the split data management information 120 indicated by the identifier 103 is present only in the storage device 15a, the information is loaded from the file of a path in the storage device 15a indicated by the identifier 103.

Next, in order to be able to judge based on values of states 125 whether or not sub-jobs have already been executed, states 125 of all the entries whose job ID 122 matches the ID of a job to be executed among the entries of the split data management information 120 indicated by the identifier 103 are deleted (Step 1109). However, where the job net is rerun after abnormally ending (Step 1108), the processing of the normally-terminated split data is not executed, and therefore the state 125 of only an entry whose state 125 is “abnormal” among the entries whose job ID 122 matches the ID of the job to be executed is deleted (Step 1110).

A sub-job scheduling process 1200 is executed to make the execution server 20 to execute the number of sub-jobs indicated by the split number 104. If all the states 125 of the entries of the split data management information 120 whose job ID 122 matches the job ID of the executed job are “abnormal” or unset (Step 1111), there is no split data to be executed in the next job, and therefore the process 1100 is terminated. If not, the next job is selected.

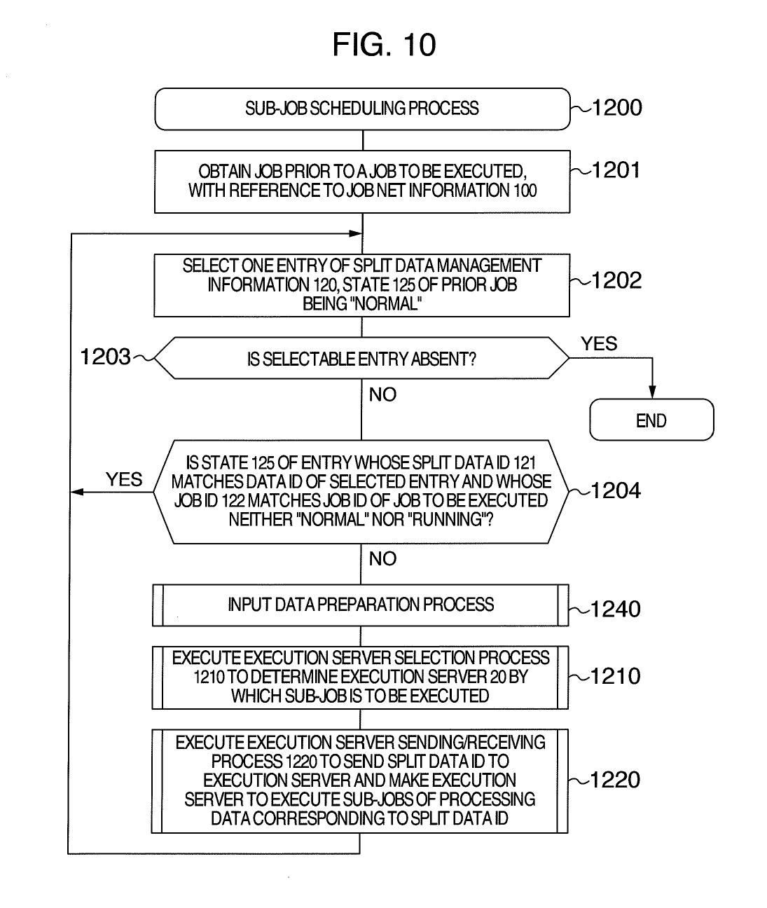

FIG. 10 shows a flowchart of the sub-job scheduling process 1200 in the job scheduling processing section 1000. First, a job prior to the job to be executed is obtained with reference to the job net information 100 (Step 1201). That is, a job ID 101 of an entry immediately before an entry whose job ID 101 matches the job ID of the job to be executed is set to the job ID of the prior job.

Next, split data to be executed is selected. Such a split data ID 121 is selected that the state 125 of an entry whose job ID 122 matches the job ID 101 of the prior job is “normal” (Step 1202). If a selectable split data ID is absent, the process 1200 is terminated (Step 1203). An entry of the split data management information 120 whose split data ID 121 matches the data ID of a selected entry, whose job ID 122 matches the job ID of a job to be executed, and whose state 125 is neither “normal” nor “running” (is “unset” or “abnormal”) is obtained (Step 1204).

Next, an input data preparation process 1240 is executed, and where the input data of a job to be executed cannot be accessed, the prior job is traced back to and executed so as to be able to access the input data. Finally, after executing an execution server selection process 1210 and an execution server sending/receiving process 1220, the process returns to Step 1202 in order to process the next split data. The execution server 20 to which sub-jobs are to be submitted is determined, and split data IDs are sent to the execution server to make the execution server execute sub-jobs of processing the data corresponding to the split data IDs.

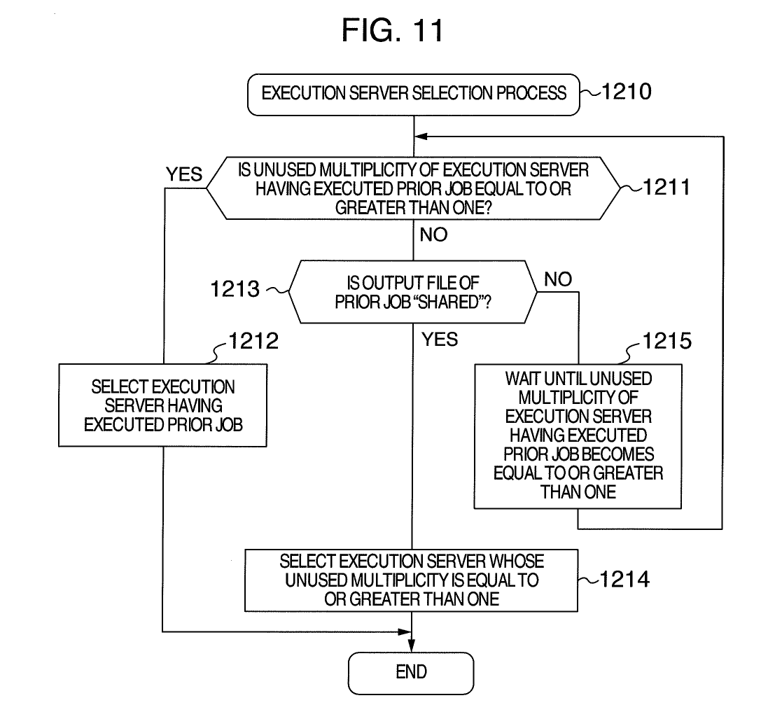

FIG. 11 shows a flowchart of the execution server selection process 1210 in the job scheduling processing section 1000. If the unused multiplicity 143 of an entry whose server ID 141 matches the server ID 124 of the execution server 20 (execution server of the entry of the prior job) having executed the prior job of the split data ID 121 is equal to or greater than one (Step 1211), the execution server 20 having executed the prior job is selected as an execution server 20 executing the sub-jobs (Step 1212). Here, the information for identifying the program 2100 is, for example, the name and argument of the program 2100, a job script, or an identifier of the job script.

If the server state 142 of the execution server 20 having executed the prior job is “abnormal” or the unused multiplicity 143 thereof is 0, and if the output file sharing information of the prior job is “shared” (Step 1213), then the output file of the prior job can be input from other execution servers, and therefore an entry whose unused multiplicity 143 is equal to or greater than one is searched from the execution server management information 140, and an execution server indicated by the server ID 141 of the entry is selected as the execution server 20 executing the sub-job (Step 1214).

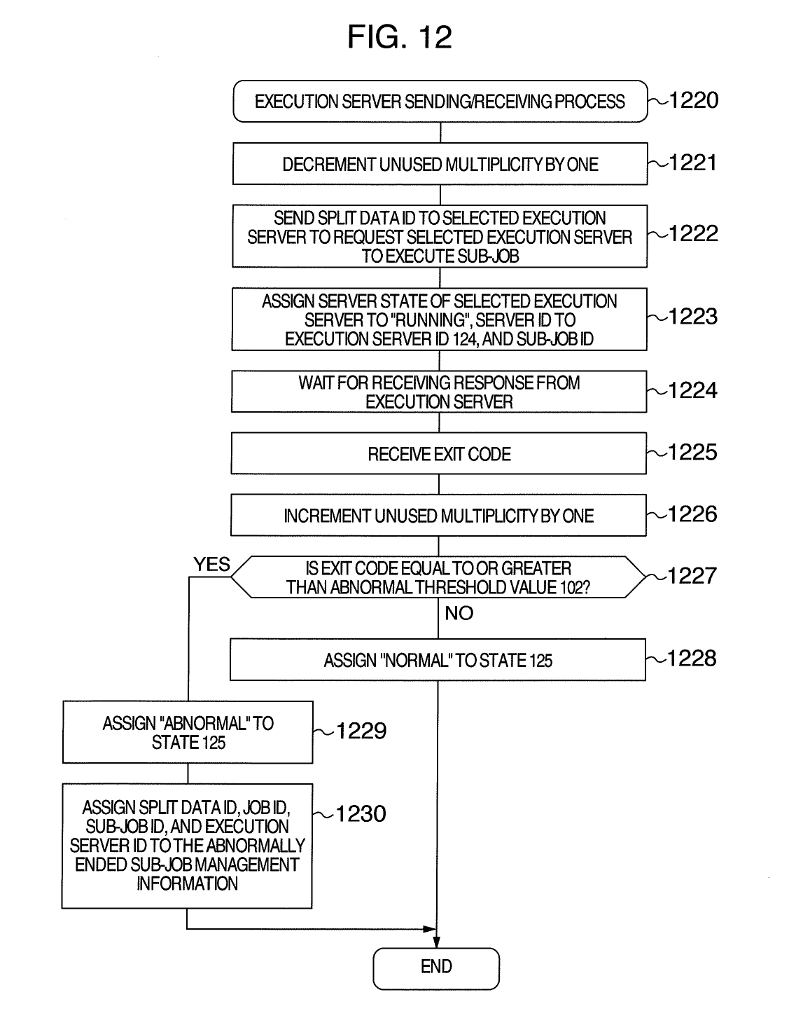

If the output file sharing information of the prior job is not “shared”, the process waits until the unused multiplicity of the execution server 20 having executed the prior job becomes equal to or greater than 1, or returns to Step 1202 to select other split data IDs (Step 1215). FIG. 12 shows a flowchart of the sending/receiving process 1220 with respect to an execution server in the job scheduling processing section 1000. First, the unused multiplicity 143 of an entry whose server ID 141 matches the server ID of the selected execution server 20 is decremented by one (Step 1221), and the information for identifying the data processing program 2100 executed in the sub-job and the split data ID are sent to the sub-job execution control processing section 2000 of the execution server 20 having executed the prior job, and the sub-job execution control processing section 2000 is requested to execute the sub-job (Step 1222). For the server ID of the selected execution server, the server ID 141 of an entry of the split data management information 120 whose split data ID 121 matches the sent split data ID and whose job ID 122 matches the job ID of a sub-job to be executed is assigned to the execution server ID 124, “running” is assigned to the server state 125, and the sub-job ID is assigned to the sub-job ID 123 (Step 1223). The sub-job ID is, for example, the sequence number incremented by one every time a sub-job is requested to be executed.

Next, the process waits for receipt of response from the execution server (Step 1224), and receives the exit code (Step 1225), and the unused multiplicity 143 of an entry whose server ID 141 matches the server ID of the selected execution server 20 is incremented by one (Step 1226). If the exit code is equal to or greater than the abnormal threshold value 102 (Step 1227), “normal” is assigned to the state 125 of an entry of the split data management information 120 whose job ID 122 matches the job ID of the sub-job to be executed (Step 1228). If the exit code is less than the abnormal threshold value 102, then “abnormal” is assigned to the state 125 (Step 1229), an entry is allocated to the abnormally ended sub-job management information 130, and the split data ID 121 is assigned to the split data ID 131, the job ID 122 to a job ID 132, the sub-job ID 123 to a sub-job ID 133, and the server ID 124 to a sub-job ID 134, respectively (Step 1230).

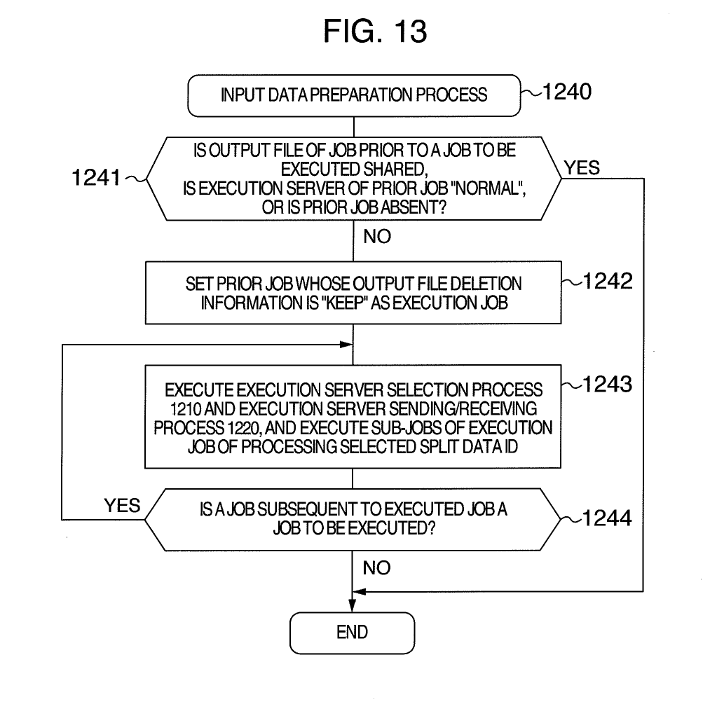

FIG. 13 shows a flowchart of the input data preparation process 1240 in the job scheduling processing section 1000. If the output file sharing information 112 of an entry of the job information 110 whose job ID 111 matches the job ID of a job prior to the job to be executed is “shared”, if the state 142 of a server whose server ID 141 matches the execution server ID 124 of an entry of the prior job is “normal”, or if a prior job is absent, then it is deemed that the input data is accessible, and the process 1240 is terminated (Step 1241).

If it is inaccessible, a prior job whose input data is present is traced back to and executed. That is, with reference to the job net information 100, a prior job whose output file deletion information is “KEEP” (the output data of the prior job is not deleted and remains) or a prior job which is not preceded by any jobs is traced back to and obtained, and is set to an execution job (Step 1242). In order to execute sub-jobs of processing split data IDs selected for the execution job, the execution server selection process 1210 and the execution server sending/receiving process 1220 are executed (Step 1243). If a job subsequent to the executed job is a job to be executed, the process 1240 is terminated, and if it is not a job to be executed, the subsequent job is set as a job to be executed and the process returns to Step 1243 (Step 1244).

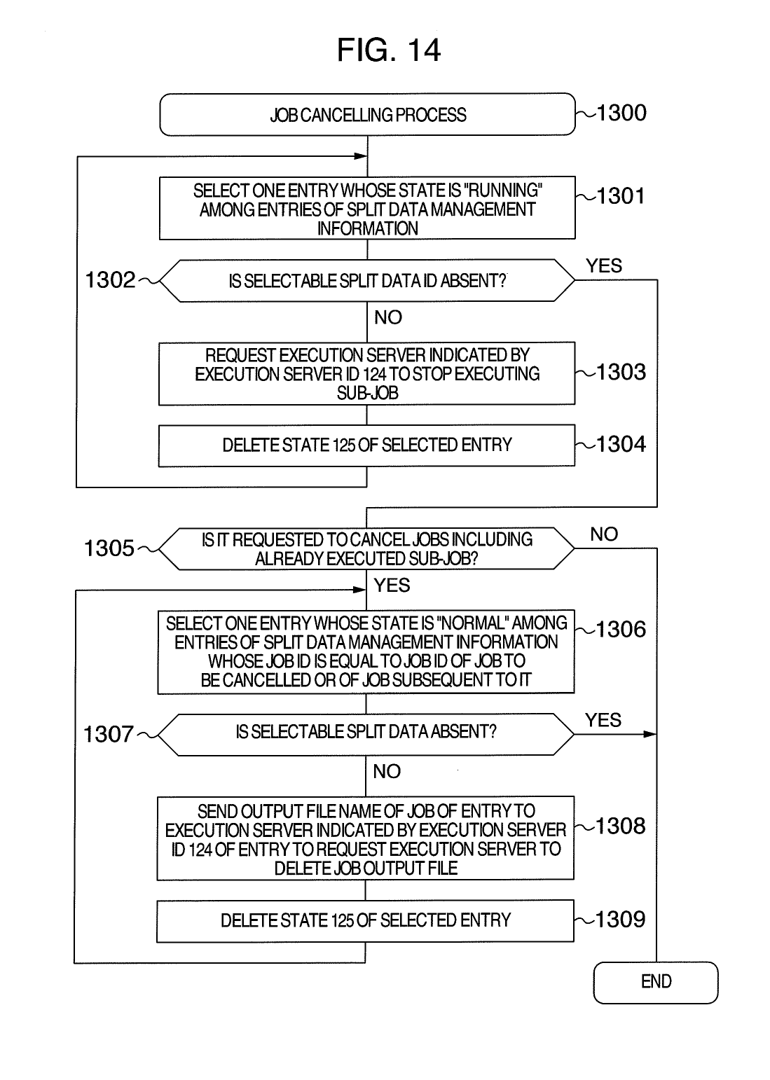

FIG. 14 shows a flowchart of a job canceling process in the job scheduling processing section 1000. First, executing a running sub-job is stopped. Even if requested to stop a specific job, a job prior or subsequent to the specific job may be running, and therefore all jobs with the same split data management information identifier 103 are to be stopped. Among the entries of the split data management information 120, one entry whose state 125 is “running” is selected (Step 1301). If a selectable entry is absent, the process proceeds to Step 1305 (Step 1302). The processing section 2000 of the execution server 20 indicated by the execution server ID 124 of the selected entry is requested to stop executing the sub-jobs (Step 1303). The states 125 of the entries are set to “blank” (Step 1304).

When the sub-job's abnormal end is not caused by data error, etc. specific to sub-jobs, but is caused by a program error affecting the entire job, etc., the entire job needs to be rerun. However, even if some sub-jobs have been abnormally ended, the subsequent job is executed, and therefore the output files of already executed sub-jobs belonging to the job to be rerun or to a job subsequent to it remains in the storage device 15b or in the storage device 15c. For this reason, if a request to cancel sub-jobs including already executed sub-jobs is specified when requesting a job cancel (Step 1305), the output files of the executed sub-jobs is deleted.

Among entries of the split data management information 120 whose job ID 122 matches the job ID of the job to be cancelled and a job subsequent to it (a job of an entry located after the job to be cancelled in the job net information 100), one entry whose state 125 is “normal” is selected (Step 1306). If a selectable entry is absent, the job canceling process is terminated (Step 1307). The output file name 114 (after “#” is replaced with the split data ID) of an entry whose job ID 122 matches the job ID 111 of the job information 110 is sent to the processing section 2000 of the execution server 20 indicated by the execution server ID 124 of the selected entry to request the processing section 2000 to delete the output file (Step 1308). The state 125 of the entry is set to “blank” (Step 1309).

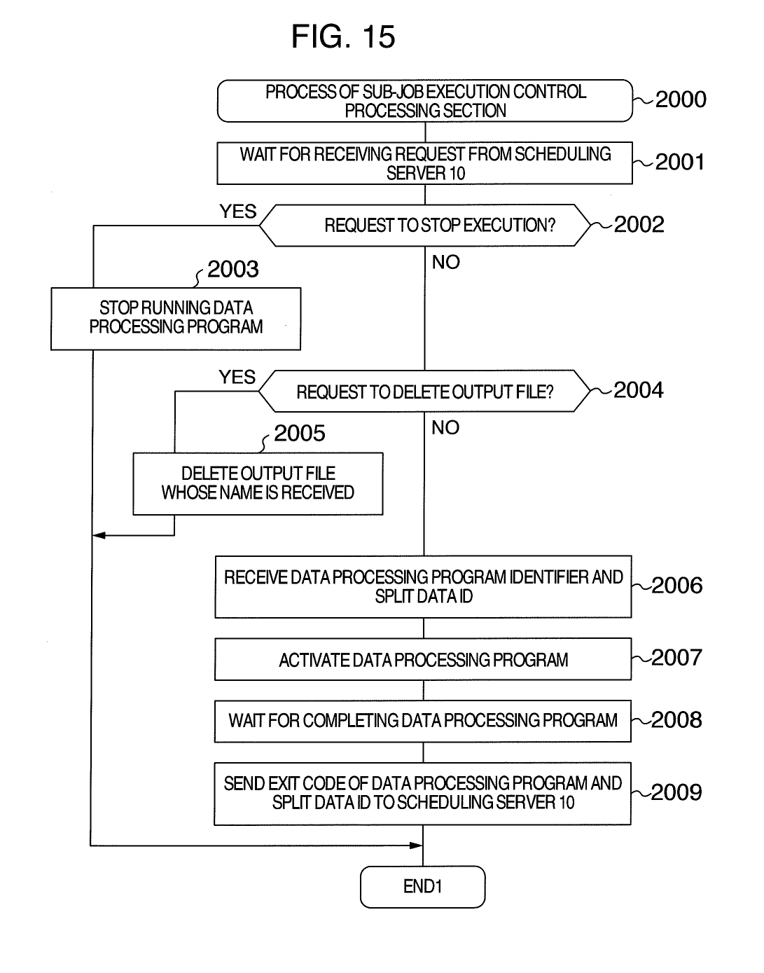

FIG. 15 shows a process flowchart of the sub-job execution control processing section 2000. After activation, the processing section 2000 waits until it receives a request from the scheduling server 10 (Step 2001). Where a request to stop execution is received (Step 2002), executing the program 2100 is stopped (Step 2003). Where a request to delete an output file is received (Step 2004), the file of the received file name is deleted (Step 2005).

Upon receiving a request to process a sub-job, the information for identifying the data processing program 2100 to be executed by the sub-job and the split data ID for identifying the data to be processed by the program 2100 are received (Step 2006), and the program 2100 is activated to process the data corresponding to the received split data ID (Step 2007). Upon completing the program 2100 (Step 2008), the exit code and the split data ID are sent to the scheduling server 10 (Step 2009).

In the foregoing, the embodiment of the present invention has been described, but this embodiment is exemplary only for description of the present invention, and the scope of the present invention is not intended to be limited only to this embodiment. The present invention can be also implemented in other various forms without departing from the spirit and scope thereof.

### Reference Signs List

1: Computer System

2: Communication Channel

10: Scheduling Server Computer

11: Main Storage Device

12: CPU

13: Communication Interface

14: Input/output Interface

15a: Scheduling Server's Storage Device

15b: Storage Device Shared Among Execution Servers

15c: Storage Device Unshared Among Execution Servers

20: Execution Server Computer

21: Input File

22: Files into Which Input File is Split

23: Intermediate File

100: Job Net Information

110: Job Information

120: Split Data Management Information

130: Abnormally Ended Sub-job Management Information

140: Execution Server Management Information

1000: Job Scheduling Processing Section

2000: Sub-job Execution Control Processing Section

1. A computer system comprising a plurality of computers having a storage device, wherein
a first one of the computers includes:
a means for defining an execution sequence of a plurality of jobs which belong to a job net of the same system stored in the storage device and process the same data;
a means for assigning data IDs for uniquely identifying pieces of data into which the data is split to associate the data IDs with the pieces of data, and for storing the data IDs in the storage device as job net information; and
a means for sending a request to execute a sub-job together with a data ID of one of the pieces of data to a second one of the computers, the data which a first job of the plurality of jobs executes being replaced with the pieces of data, wherein the second computer includes:
a means for receiving a termination state and the data ID of the sent sub-job, and wherein
the first computer further includes:
a means for memorizing, in the storage device, split data management information storing the data ID, the termination state, and a job identifier for uniquely identifying the first job corresponding to the sub-job within the job net, which are associated with each other; and
a means for sending a request to execute a sub-job together with the data ID of one of the pieces of data to the second computer, the data of a second job being replaced, with reference to the split data management information, with pieces of data indicated by data IDs of the split data management information whose job identifier is an identifier of the second job to be executed immediately after the first job in accordance with the execution sequence and whose termination states are not normal, among pieces of data indicated by data IDs of the split data management information whose job identifier is an identifier of the first job and whose termination states are normal.

2. The computer system according to claim 1, wherein
a first computer includes:
a means for memorizing, in the split data management information, a server ID for uniquely identifying the computer having executed the sub-job of processing a piece of data indicated by a data ID stored in the split data management information; and
a means for sending a request to execute a sub-job of the second job to a second computer indicated by a server ID of the split data management information containing a data ID of a piece of data of the sub-job and an identifier of the first job.

3. The data split processing control system according to claim 1, wherein
a first computer includes:
a means for receiving a request to cancel the first job;
a means for identifying an output file of a sub-job of the second job; and
a means for invoking a deletion process of the file output by the sub-job of the second job, upon receiving the request to cancel the first job.

4. The computer system according to claim 1, wherein
a first computer includes:
a means for judging whether or not an output file of the first job is accessible from an arbitrary one of the computers; and
a means for sending, to the second computer, a request to execute the second job of processing a piece of data processed by the sub-job, where an output file of the first job is accessible from the arbitrary computer.

5. The computer system according to claim 1, wherein
a first computer includes:
a means for judging whether or not an output file of the first job is accessible from the arbitrary second computer;
a means for, when a sub-job of a third job to be executed in accordance with the execution sequence immediately before the first job has been normally terminated, judging whether or not an output file of the third job input to the first job is set so as to be deleted; and
a means for, where a file output by a sub-job of the first job is accessible only from the second computer having executed a sub-job of the first job and the second computer having executed a sub-job of the first job is in an abnormal state, executing a sub-job of the second job after executing a sub-job of the first job if an output file of the third job is set so as not to be deleted, or executing a sub-job of the second job after executing the third job and the first job if an output file of the third job is set so as to be deleted.

6. A data processing control method in a computer system comprising a plurality of computers having a storage device, wherein
a first one of the computers:
defines an execution sequence of a plurality of jobs which belong to a job net of the same system stored in the storage device and process the same data;
assigns data IDs for uniquely identifying pieces of data into which the data is split to associate the data IDs with the pieces of data, and stores the data IDs in the storage device as job net information; and
sends a request to execute a sub-job together with a data ID of one of the pieces of data to a second one of the computers, the data which a first job of the plurality of jobs executes being replaced with the pieces of data, wherein
the second computer receives a termination state and the data ID of the sent sub-job, and wherein
the first computer:
memorizes, in the storage device, split data management information storing the data ID, the termination state, and a job identifier for uniquely identifying the first job corresponding to the sub-job within the job net, which are associated with each other; and
sends a request to execute a sub-job together with the data ID of one of the pieces of data to the second computer, the data of a second job being replaced, with reference to the split data management information, with pieces of data indicated by data IDs of the split data management information whose job identifier is an identifier of the second job to be executed immediately after the first job in accordance with the execution sequence and whose termination states are not normal, among pieces of data indicated by data IDs of the split data management information whose job identifier is an identifier of the first job and whose termination states are normal.

7. The data processing control method according to claim 6, wherein
the first computer:
memorizes, in the split data management information, a server ID for uniquely identifying the computer having executed the sub-job of processing a piece of data indicated by a data ID stored in the split data management information; and
sends a request to execute a sub-job of the second job to a second computer indicated by a server ID of the split data management information containing a data ID of a piece of data of the sub-jobs and an identifier of the first job.

8. The data processing control method according to claim 6, wherein
the first computer:
receives a request to cancel the first job;
identifies an output file of a sub-job of the second job; and
invokes a deletion process of the file output by the sub-job of the second job, upon receiving the request to cancel the first job.

9. The data processing control method according to claim 6, wherein
the first computer:
judges whether or not an output file of the first job is accessible from an arbitrary one of the computers; and
sends a request to execute the second job of processing a piece of data processed by the sub-job to the second computer, where an output file of the first job is accessible from the arbitrary computer.

10. A data processing control program making a computer system function, the computer comprising a plurality of computers having a storage device, wherein the data processing control program includes:
a first one of the computers
defining an execution sequence of a plurality of jobs which belong to a job net of the same system stored in the storage device and process the same data,
assigning data IDs for uniquely identifying pieces of data into which the data is split to associate the data IDs with the pieces of data, and storing the data IDs in the storage device as job net information, and
sending a request to execute a sub-job together with a data ID of one of the pieces of data to a second one of the computers, the data which a first job of the plurality of jobs executes being replaced with the pieces of data;
the second computer
receiving a termination state and the data ID of the sent sub-job; and
the first computer
memorizing, in the storage device, split data management information storing the data ID, the termination state, and a job identifier for uniquely identifying the first job corresponding to the sub-job within the job net, which are associated with each other; and
sending a request to execute a sub-job together with the data ID of one of the pieces of data to the second computer, the data of a second job being replaced, with reference to the split data management information, with pieces of data indicated by data IDs of the split data management information whose job identifier is an identifier of the second job to be executed immediately after the first job in accordance with the execution sequence and whose termination states are not normal, among pieces of data indicated by data IDs of the split data management information whose job identifier is an identifier of the first job and whose termination states are normal.
